(19) United States
(12) Patent Application Publication
(10) Pub. No.: US 2009/0109288 A1
(43) Pub. Date: Apr. 30, 2009

(54) Moving vehicle video recording rear-view mirror

(76) Inventor: Ming Hsiu Wu, Chunghua County (TW)

Correspondence Address: BIRCH STEWART KOLASCH & BIRCH, PO BOX 747, FALLS CHURCH, VA, 22040-0747, US

(21) Appl. No.: 11/976,882

(22) Filed: Oct. 29, 2007

(51) Int. Cl. H04N 7/18

(52) U.S. Cl. 348/148; 348/E07.085

(57) ABSTRACT

This invention provides a kind of moving vehicle video recording rear-view mirror, which contains a fixing clamp installed at the back of main body for embedding rear-view mirror of original vehicle; wherein a storage device is installed on the top and beneath is a controller board; the front of main body is installed with a mirror, wherein a corner of the mirror is installed with a liquid crystal display; the exterior of main body is installed with a video camera for retrieving moving vehicle video information to be used together with storage device for saving information; through which the storage device will back up above stated storage information to provide strong evidence and as protection to the accident and resolving problem for the driver which is difficult to identify, and allows policemen and assessing personnel to find out true cause of the accident in order to protect the right of driver.

### FIELD OF THE INVENTION

The present invention relates to a moving vehicle video recording rear-view mirror, and more particularly to an innovative rear-view mirror for the recording and storage of external video image that is adapted to the vehicle after activating the vehicle (ignition) in order to protect the right of the driver.

### BACKGROUND OF THE INVENTION

Driving cars has become one of the necessary skills in our daily life. With the increase in number of vehicles and congestion in traffic system, accidents caused by drivers are causing numerous human lives and loss of properties. Both parties of the accident or policemen settling the problem are having difficulty in surveying the site of the accident, collecting evidence, investigating witnesses, writing reports and filling forms and yet still unable to find out the real position of the collision of vehicle causing accident. Therefore, there will be great difference between the report and the actual situation, creating continuous argument. In addition, reconstruction of the site of accident is difficult and each party has there own story, and there is no solid proof of the actual movement of driver's vehicle, all these tend to slow down the speed of investigation and unable to allow the evaluation personnel to identify the real cause of accident. Hence, the driver might encounter lawsuit and face mistrial and civilian or criminal responsibility which seriously affecting a person's right. Worse case the credibility of judiciary system could become questionable.

Hence, in view of this, this invention is to overcome above stated problems by providing a kind of video recording rear-view mirror for moving vehicle, which can be installed on the vehicle to effectively record and store the outside environment AV information during driving.

### SUMMARY OF THE INVENTION

The primary objective of this invention is in providing a kind of moving vehicle video recording rear-view mirror, wherein a video camera is used to retrieve the video image of moving vehicle directly and storing in a storage device, which is helpful in preventing traffic accident and providing strong evidence for the accident in order to resolve the problem driver is facing which is hard to clarify and allow the policeman and assessing personnel to identify the true cause of the accident so as to protect the right of driver.

To achieve the above stated objective, the moving vehicle video recording rear-view mirror provided by this invention is mainly in installing at the back of the main body a fixing clamp for embedding the rear-view mirror of the original vehicle, wherein a storage device is installed at the top and underneath has a control board; the front of the said main body is installed with a mirror; the said mirror is designed with a liquid crystal display; external to the said main body is installed with a video camera for retrieving image information of the moving vehicle, to be used with a storage device for the storage of information file and transmitting the video information to the said liquid crystal display through a CPU chip.

Comparing to the prior art, the moving vehicle video recording rear-view mirror of this invention is suitable to the installation of the rear-view mirror of all kinds of vehicle. When accident happens, the files store in the storage device can be backed up as evidence for clarifying the responsibility of the accident.

### BRIEF DESCRIPTION OF THE DRAWINGS

FIG. 1 is the illustration of complete assembly of this invention;

FIG. 2 is the illustration of the rear-view mirror of the original vehicle before completion of installation of the present invention;

FIG. 3 is the illustration of block diagram of the moving vehicle video recording device of the present invention.

### DETAILED DESCRIPTION OF THE PREFERRED EMBODIMENTS

Hereafter the detailed description and detail of the present invention is explained below together with the help of diagrams and physical embodiments:

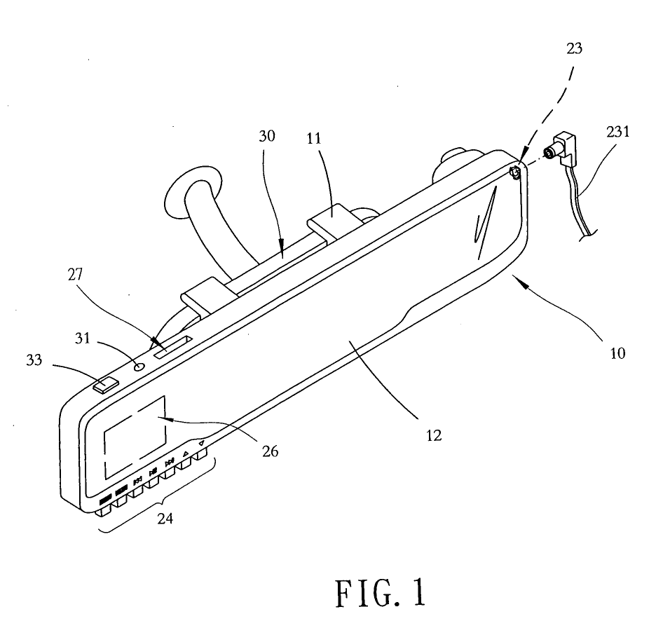

FIG. 1 is the illustration after completion of installation of this invention. From this diagram it is easy to understand that the back of the main body (10) is installed with a fixing clamp (11) for embedding the rear-view mirror (30) of the original vehicle; whereon is installed with a storage device (27) and underneath a controller board (24) is provided; the said main body (10) is installed with a power input (23) for the connection to a conducting wire (231); the front of the said main body (10) is installed with a mirror (12), a corner of the said mirror (12) is designed with a liquid crystal display (26).

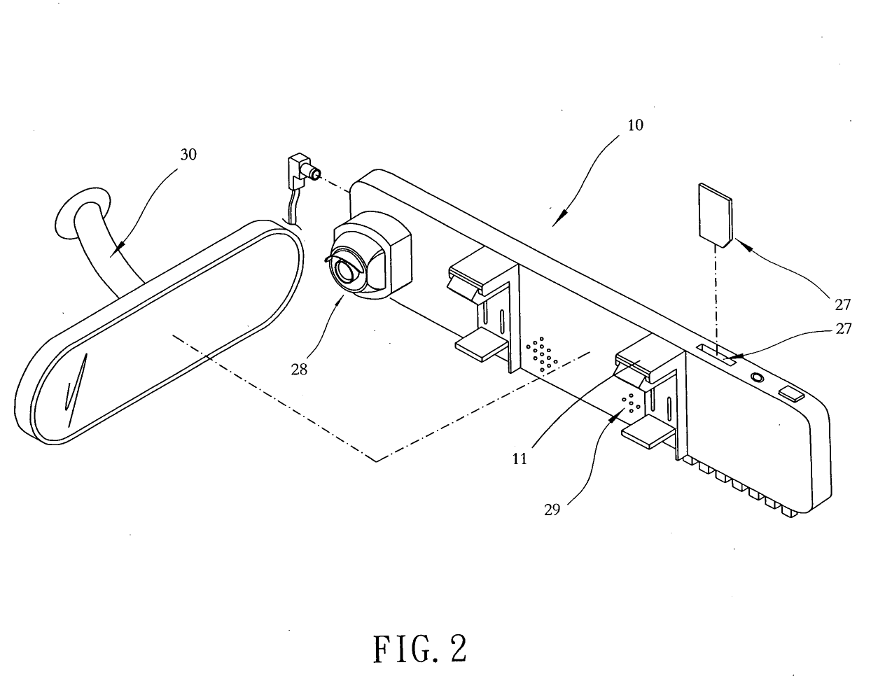

FIG. 2 is the illustration of this invention with the rear-view mirror of the original vehicle before completion of assembly. It is easy to understand from the diagram that the fixing clamp (11) is a concaved design for ease of installing on the rear-view mirror (30) of the original vehicle, and the said fixing clamp (11) has the flexible function that could be firmly fixed onto the rear-view mirror (30) of any size of the original vehicle and can be easily removed afterwards; also at one side of the back of the main body (10) a video camera (28) is installed; within the fixing clamp (11) several microphones (29) are distributed; at the top of the said main body (10) a storage device (27) is installed.

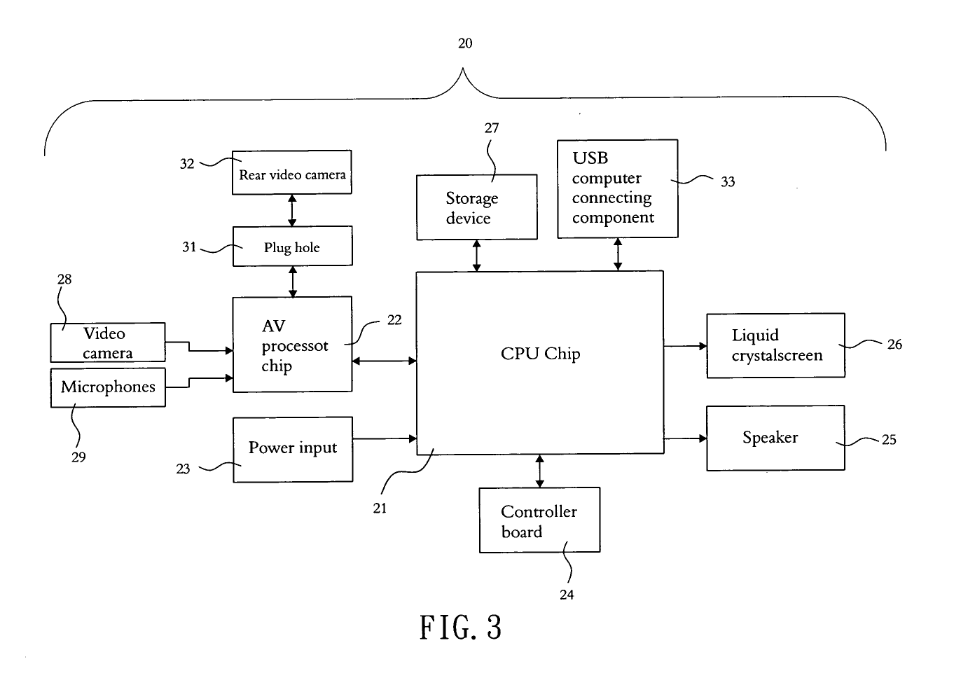

FIG. 3 is the illustration of the block diagram of the moving vehicle video recording device of this invention. The said moving vehicle video recording device (20) is installed on the said main body (10) (please refer to FIG. 1), including a CPU chip (21) an AV processor chip (22), a power input (23), a controller board (24), a speaker (25) a liquid crystal display (26), and a storage device (27).

The CPU chip (21) stated above is for connection to AV processor chip (22), power input (23), controller board (24), speaker (25), liquid crystal display (26) and storage device (27).

In addition, the CPU chip (21) stated above is for connecting to AV processor chip (22) for the operation and processing of the said digital AV signals; again, the said CPU chip (21) is for connecting to a USB computer connecting component (33); the said USB computer connecting component (33) can be in turn connected to another computer.

The AV processor chip (22) stated above is for accepting AV signals from outside world, which can be converted to digital AV output signal; the said AV processor chip (22) can be connected to a video camera (28) for retrieval of moving vehicle video information; and, the said AV processor chip (22) cab be connected to a microphone (29); the said microphone (29) is a sound receiving microphone.

In addition, the said AV processor chip (22) is for connecting to a plug hole (31), the said plug hole (31) can in turn be connected to a rear video camera (32). Usually the said rear video camera (32) is installed on the rear bumper of a vehicle so that when reversing the vehicle the said rear video camera (32) will broadcast the retrieved rear video information on the liquid crystal display (26) for the driver to refer to during reversing vehicle.

The power input (23) stated above is for connecting to the said CPU chip (21); the said power input (23) is to use a conducting wire (231) to connect to the cigarette lighter of the vehicle as the source of power, for providing the normal operation of the said mechanism.

The said controller board (24) is for connecting to the said CPU chip (21) for turning on/off operations of microphone (29), speaker (25), video camera (28), liquid crystal display (26), power input (23), and storage device (27); the said controller board (24) is installed with at least an operating key (241) for providing the user with selection of different working modes.

The speaker (25) stated above is for conveying audio message to the driver.

The liquid crystal display (26) stated above is a display with LCD panel, hence is to facilitate the driver to play back the video information of the moving vehicle retrieved from the said video camera (28) directly on the said liquid crystal display (26); naturally, the said liquid crystal display (26) can also be used for playing back the rear video information retrieved from the rear video camera (32) for viewing.

The storage device (27) stated above is for connecting to the said CPU chip (21) so that the file of the moving vehicle video information retrieved from the video camera (28) can be recorded and saved; for the same reason, the rear video information retrieved from the rear video camera (32) can also be processed similarly; the said storage device (27) is a SD memory card interface that can be carried to other AV playback device for broadcasting purpose.

Through the above assembly, as shown in FIGS. 1 through 3, this invention mainly makes use of the moving vehicle video recording device (20) installed on the main body (10) to retrieve moving vehicle video information through the video camera (28) for operation and processing, and record and store file information through storage device (27) by connecting through AV processor chip (22) and again to CPU chip (21). Driver uses controller board (24) to set different operating scenario and open/close each said component; the said CPU chip (21) transmit video information synchronously to liquid crystal display (26) in order for the external video information while vehicle is moving being played back through the said liquid crystal display (26) afterwards. Similarly, it can also play back the rear video information retrieved by the rear video camera. Therefore, when accident happens, the information stored in the said storage device (27) can be backed up as strong evident in order to resolve the problem driver could not quickly resolve in the past and allows the police authority and assessment personnel to judge the true cause of the accident so as to protect driver's right.

The above stated is for the explanation of the embodiment of this invention and by no means to restrict this invention in any form. Therefore, any change or modification related to this invention with the same creative spirit should all be protected under this invention.

What is claimed is:

1. A kind of moving vehicle video recording rear-view mirror, including:
A main body, the back of which is installed with a fixing clamp for embedding rear-view mirror of original vehicle, the front is assembled with a mirror; and
A moving vehicle video recording device, installed on the said main body, which contains CPU chip, AV processor chip, power input, controller board, speaker, liquid crystal display, and storage device, etc; where:
The said CPU chip is for connecting to AV processor chip, power input, controller board, speaker, liquid crystal display, and storage device, respectively;
The said AV processor chip is for connecting to a video camera and a microphone;
The said power input for connecting to the power of the vehicle;
The said controller board for activating the operation of microphone, speaker, video camera, liquid crystal display, power input, and storage device;
The said speaker is for providing voice message to driver;
The said liquid crystal display is for broadcasting of the retrieved moving video image of the said video camera; and
The said storage device for the recording and storing of moving vehicle images retrieved by the said video camera.

2. the moving vehicle video recording rear-view mirror as stated in claim 1 above, where the said CPU chip is for connecting to a USB computer connecting component.

3. the moving vehicle video recording rear-view mirror stated in claim 1, where the said AV processor chip can be connected to a plug hole; the said plug hole is also connected to a rear video camera.

4. the moving vehicle video recording rear-view mirror stated in claim 1, where the said power input is a conducting wire connecting to a cigarette lighter on a vehicle.

5. the moving vehicle video recording rear-view mirror stated in claim 1, where the said controller board is installed with at least a operating key.

6. the moving vehicle video recording rear-view mirror stated in claim 1, where the said storage device is a SD memory card.

7. the moving vehicle video recording rear-view mirror stated in claim 1, where the said microphone is a sound receiving microphone.
